(19) United States
(12) Patent Application Publication
(10) Pub. No.: US 2009/0293472 A1
(43) Pub. Date: Dec. 3, 2009

(54) Apparatus and process for recovering energy from bouyancy and gravitational forces

(76) Inventor: David Propp, Ponte Vedra Beach, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/455,360

(22) Filed: Jun. 1, 2009

Related U.S. Application Data
(60) Provisional application No. 61/130,439, filed on May 30, 2008.

(51) Int. Cl. F03B 17/02

(52) U.S. Cl. 60/496

(57) ABSTRACT

An apparatus and process for capturing power or mechanical work from the kinetic energy of a moving vessel driven by buoyancy and gravitational forces. The apparatus comprises a main tank, a charging vessel located at the bottom of the main tank, a moving vessel, a compression tank located above the main tank, and a hose connecting the compression tank to the charging vessel. A piston, which is rigidly attached to the moving vessel, moves up and down inside the compression tank compressing the gas therein and forcing it into the charging vessel. When the moving vessel engages a contact valve attached to the charging vessel, the compressed gas enters the moving vessel causing it to become buoyant. The moving vessel is driven by buoyancy and gravitational forces and moves cyclically upward and downward within the main tank, thereby driving an energy recovery means, such as a lever arm, and performing mechanical work.

This application claims the benefit of U.S. Provisional Patent Application Ser. No. 61/130,439, filed on May 30, 2008.

### BACKGROUND OF THE INVENTION

Within the past decade, there has been an increasing trend of public awareness about environmentally friendly energy sources, or “alternate” energy sources. Most alternate energy sources suffer from poor efficiency and are unable to deliver power in the quantity or for the duration that would serve as a viable alternate to traditional energy sources, such as fossil fuels. Other alternate energy sources, such as solar panels or windmills, depend on certain environmental conditions for their process to function properly. Other alternate energy sources depend on external pumps, compressors, or energy sources as a manner of driving or sustaining the system. Such systems demand a high level of maintenance and are not conducive to being transported to remote locations.

The present invention seeks to overcome these problems by delivering a clean, self-contained and self-driven energy source that can be transported to almost any location.

### SUMMARY OF THE INVENTION

The present apparatus and process are capable of delivering useable power or mechanical work by capturing and converting the kinetic energy released from a vessel driven up and down through water by buoyancy forces and gravitational forces. The apparatus has a main tank partially filled with water, a charging vessel located at the bottom of the main tank, a moving vessel capable of moving cyclically up and down through the water in the main tank, a compression tank located above the main tank, and a hose connecting the compression tank to the charging vessel. The compression tank incorporates a piston that is rigidly connected to the moving vessel. As such, the piston has an upstroke and a down stroke corresponding to the movement of the moving vessel. A lever arm is attached to the moving vessel or a piston rod, and the moving vessel drives the lever arm.

In use, the moving vessel moves cyclically upward and downward within the main tank. As the moving vessel moves down under gravity, the moving vessel pulls the piston toward the bottom of the compression tank, thereby drawing gas into the tank. The moving vessel continues to drop until it engages the charging vessel, which releases compressed gas into the moving vessel, thereby causing the buoyancy forces to exceed the gravitational forces. Under this condition, the moving vessel moves upward through the water in the main tank, thus causing the piston rod to force the piston back to the top of the compression tank, which compresses the gas that entered the tank when the piston initially dropped. The compressed gas exits the compression tank and moves along a hose and into the charging vessel. The movement of the moving vessel up and down is used to drive the lever arm, thereby performing mechanical work.

### BRIEF DESCRIPTION OF THE DRAWINGS

FIG. 1 is an elevation view of one embodiment of the apparatus, showing a cross section of the compression tank and the main tank, with the entry valves and exit valves on the top of the compression tank.

FIG. 2 is an elevation view of one embodiment of the apparatus, showing a cross section of the compression tank and the main tank, with the entry valves and exit valves on the bottom of the compression tank.

FIG. 3 shows a front perspective view of one embodiment of the charging vessel (removed from the main tank) with the guide rod attached and the moving vessel fitted over the guide rod.

FIG. 4 shows a partial elevation of one embodiment of a gas release means of the moving vessel.

### DETAILED DESCRIPTION OF THE INVENTION

With reference to the drawings, the invention will now be described with regard for the best mode and the preferred embodiment. In general, the invention is an apparatus and a self-contained, self-driven process of producing mechanical work and useable power by relying on buoyancy and gravitational forces. The embodiments disclosed herein are meant for illustration and not limitation of the invention. An ordinary practitioner will understand that it is possible to create many variations of the following embodiments without undue experimentation.

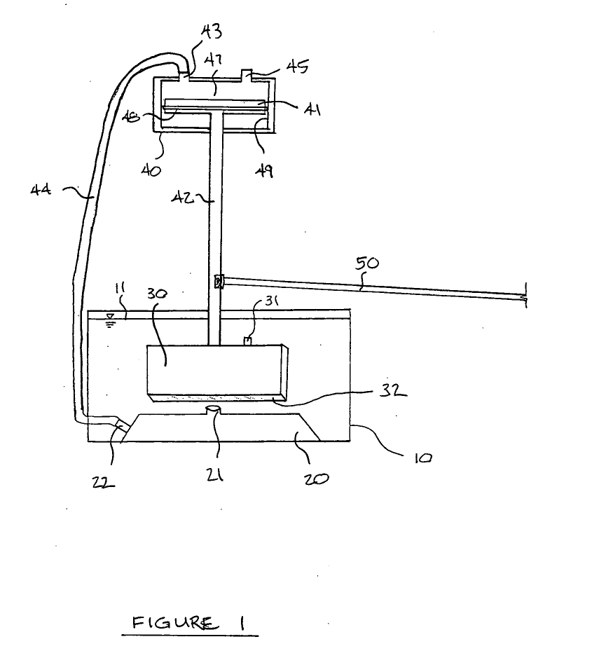

Referring to FIG. 1, the apparatus generally comprises a main tank 10, a charging vessel 20, a hollow moving vessel 30, and a compression tank 40. The main tank 10 is a watertight container filled with water to a sufficient level, as described in more detail below. The charging vessel 20 sits at the bottom of the main tank 10 below the moving vessel 30. A contact valve 21 is affixed to the top portion of the charging vessel 20, and a one-way charging valve 22 is affixed to the charging vessel 20. The charging vessel 20 is made of a material with sufficient impermeability to retain the compressed gas and sufficient rigidity to withstand the impact caused by the sinking moving vessel 30, as described below. The contact valve 21 is any valve that remains closed at all times unless it is engaged, or contacted, by the moving vessel 30. The contact valve 21 opens when it is physically engaged by the moving vessel 30.

The compression tank 40 is positioned above the main tank 10. The compression tank 40 is any type of apparatus for compressing gas, and it should be made of a material of sufficient strength to withstand the large forces developed during the gas compression process. Such materials include most metals and some high strength plastics. The compression tank 40 further comprises inside walls 49, a compression chamber 47 and a piston 41, which is attached to the moving vessel 30 by a piston rod 42. The piston 41 is made of a material having a relatively high strength to weight ratio, such as a high strength thermoplastic, carbon fiber material, or a lightweight metal. Ultra high molecular weight polyethylene, also known as high performance polyethylene, is one such material. The piston 41 incorporates a piston ring 48, such as an O-ring, thereby creating a tight-fitting seal between the piston 41 and the inside wall of the compression tank 40. A lubricant is applied to the inside walls 49, thus reducing losses due to friction between the piston 41 and the inside walls 49. The lubricant can be any suitable lubricant, as an ordinary practitioner will understand. For example, the lubricant could be a Teflon®-based, waterproof lubricant.

Near the top of the compression tank 40 is an exit valve 43 and an entry valve 45, both of which are one-way valves. The exit valve 43 and entry valve 45 are arranged with an opposite-facing orientation so as to permit gas flow in opposite directions. That is, as the piston 41 moves from the top of the compression tank 40 down towards the bottom of the tank, the piston 41 draws gas into the chamber 47 via the entry valve 45. Then, when the piston 41 moves from the bottom of the compression tank 40 towards the top of the tank, the gas inside the chamber 47 compresses. The compressed gas then leaves the chamber 47 via the exit valve 43 and enters the hose 44 that carries the compressed gas from the compression tank 40 to the charging vessel 20 via the charging valve 22. When the piston 41 moves back toward the bottom of the compression tank 40, gas enters the chamber 47 via the entry valve 45, thereby repeating the gas compression cycle.

The moving vessel 30 incorporates an impermeable cavity 32 capable of retaining gas or water without leaking. In one embodiment, the moving vessel 30 incorporates an actuator means 69 (see in FIG. 8) that engages the contact valve 21, thereby opening the valve. Near the top of the moving vessel 30 is a gas release means 31, such as a valve. The gas release means 31 must permit water to enter the cavity 32 to submerge the moving vessel 30, and the gas release means 31 must allow the gas to exit the cavity 32 when the moving vessel 30 reaches the surface of the water in the main tank 10.

The length of the piston rod 42, the location of the water surface 11, and the height of the compression tank 40 should be proportioned such that the piston 41 is at or near the top of the chamber 47 when the moving vessel 30 is at the water surface 11, and the piston 41 should be at or near the bottom of the chamber 47 when the moving vessel 30 engages the contact valve 21.

The piston rod 42 must have sufficient strength and stability to withstand the compression forces that it transmits during the piston movement cycle. An energy recovery means, such as a lever arm 50, is attached to the piston rod 42. As the moving vessel 30 moves up and down (as described below), the piston rod 42 drives the lever arm 50, thus converting the kinetic energy of the moving vessel 30 into mechanical work. The lever arm 50 can be used to drive a pump, turbine, flywheel, or any other device that uses or stores power or energy.

The apparatus has a valve control system, of which there are several possible embodiments. For example, in one embodiment the valve control system is a purely mechanical system relying on mechanical means to open and close the various valves, as discussed in more detail below. In another embodiment, the valve control system comprises computer software that controls the electronic operation of selected valves. In another embodiment, the valve control system comprises both mechanical and electronic aspects to operate certain valves.

For example, in one embodiment of the valve control system, the exit valve 43, entry valve 45, and charging valve 22 are simple mechanical valves actuated by pressure differences across the valve, as an ordinary practitioner will understand. The contact valve 21 and a gas release means 31 are electronically controlled by a remote computer. For example, the computer could be programmed to open or close the contact valve 21 and the gas release means 31 at time intervals corresponding to the period of the moving vessel 30. In another embodiment the contact valve 21 and the gas release means 31 could be fitted with pressure transducers such that the corresponding valves are controlled by the computer based on pressure changes indicated by the transducers. In this embodiment, operation of the gas release means 31 can be driven by a pressure transducer sensing the difference in hydrostatic pressure as the moving vessel 30 rises and sinks in the water. When the hydrostatic pressure approaches zero, the gas release means 31 is opened, thus allowing the moving vessel 30 to submerge. When the hydrostatic pressure reaches a predetermined level corresponding to the depth of the charging vessel 20, the gas release means 31 is closed and the contact valve 21 is opened, thus discharging compressed gas from the charging vessel 20 into the moving vessel 30.

In use, the moving vessel 30 moves cyclically upward and downward within the main tank 10 depending on whether the moving vessel's 30 cavity 32 is full of gas or water. In the initial position of the apparatus, the piston 41 is positioned near the top of the compression tank 40 and the moving vessel 30 held near the surface of the water in the main tank 10 with the cavity substantially full of water. In this embodiment, the charging vessel 20 must be primed before the moving vessel 30 is set into motion. An external gas compressor can be used to create the initial prime by introducing compressed gas into the charging vessel 20, and the charging valve 22 will retain this initial compressed gas. After this initial prime, the gas compressor can be removed, and no external compressor or energy source is needed to operate the apparatus.

Next, the moving vessel 30 is released, permitting gravity to pull the moving vessel 30 downward through the water in the main tank 10. As the moving vessel 30 drops, the piston rod 42 pulls the piston 41 toward the bottom of the compression tank 40, thereby drawing gas into the chamber 47 via the entry valve 45. The moving vessel 30 continues to drop until it engages the contact valve 21, which releases the compressed gas into the cavity 32, thereby forcing the water out of the cavity 32. As the gas enters the cavity 32, the magnitude of the main vessel's 30 upward buoyancy force grows until it becomes greater than that of the downward gravitational force. Under this condition, the moving vessel 30 moves upward through the water in the main tank 10, thus causing the piston rod 42 to force the piston 41 back through the chamber 47 thereby pressurizing the gas that entered the tank when the piston 41 initially dropped. The compressed gas exits the chamber 47 via the valve 43 and moves along the hose 44, through the charging valve 22, and into the charging vessel 20.

When the moving vessel 10 reaches the water surface 11, the gas from within the cavity 32 is released via the gas release means 31, causing the cavity 32 to refill with water and reducing the magnitude of the moving vessel's 10 upward buoyancy force below that of the gravitational force. Under this condition, the moving vessel 30 sinks down towards the contact valve 21 of the charging vessel 20, thereby repeating the process. The movement of the moving vessel 30 up and down is used to drive the lever arm 50, thereby performing mechanical work.

The apparatus will continue to operate through this cycle until it is either intentionally stopped or the system sustains substantial losses, such as gas or valve leakage. The cycle can be stopped by draining the water out of the main vessel 10, thereby eliminating the buoyancy force driving the upstroke of the main vessel 30. The apparatus will require periodic service and maintenance as required by the particular application and environmental conditions. More frequent service and maintenance may be required where the system operates in harsh environmental conditions, such as in a desert or in a corrosive saltwater environment. Also, depending on the environment and arrangement of the apparatus, water in the main vessel 10 may evaporate over time. Thus, the main vessel 10 may need to be periodically refilled with water.

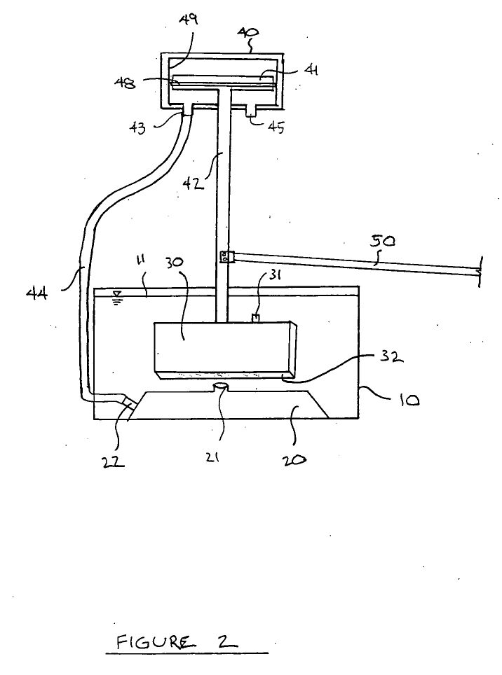

In another embodiment, as shown in FIG. 2, the exit valve 43 and entry valve 45 are located near the bottom of the compression tank 40. The process functions in substantially the same manner as previously described, except that the gas in the compression tank 40 is compressed during the piston's 41 down stroke, and gas is drawn into the chamber 47 during the piston's 41 upstroke. This embodiment has the advantage that it is self-priming, and no external gas compressor or energy source is needed to prime or operate the apparatus. The cycle begins with the piston 41 retained at the top of the upstroke. When the moving vessel 10 is released beginning the down stroke, the piston 41 charges the charging vessel 20 as described above. Before the moving vessel 30 engages the contact valve 21, the charging vessel 20 is primed with enough compressed gas to drive the upstroke of the moving vessel 30, as described above.

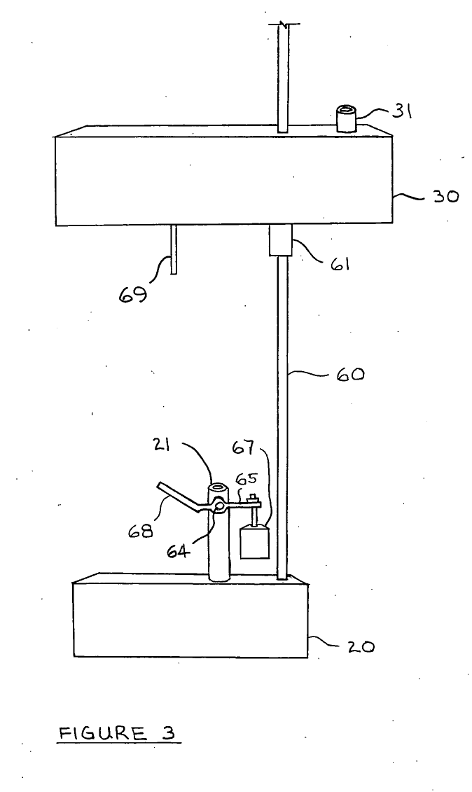

In another embodiment, shown in FIG. 3, a guide rod 60 is affixed to the charging vessel 20. The moving vessel 30 is fitted with a sleeve 61 for receiving the guide rod 60, and the sleeve 61 slides along the guide rod 60, preventing inadvertent lateral movement by the moving vessel 30. The moving vessel 30 is thereby restricted to one-dimensional movement. Inadvertent rotational motion by the moving vessel 30 can also be restrained where the guide rod 60 and sleeve 61 are not of a circular cross section. For example, a guide rod 60 and sleeve 61 can be fashioned to have a substantially square cross section. This sleeve 61 is sized to form a snug fit over the guide rod 60, thereby resisting inadvertent rotation about the longitudinal axis of the guide rod 60.

In another embodiment, the contact valve 21 is a typical plumbing valve having a control means 64. One side of the control means 64 is fitted with a closure means 65, which is any means for retaining the contact valve 21 in a closed position. The closure means 65 can be activated by a weight 67 or any other equivalent closing means. A trigger arm 68 is attached to the opposite side of the control means 64 such that when the trigger arm 68 is pressed downward, an opening force is produced. When the magnitude of the opening force exceeds that of the closing force, the contact valve 21 opens, releasing the compressed gas from charging vessel 20 into the moving vessel 30. In this-embodiment, the moving vessel 30 is fitted with an actuator means 69. When the moving vessel 30 is at the bottom of the down stroke, the actuator means 69 engages the trigger arm 68, depressing the arm and opening the contact valve 21.

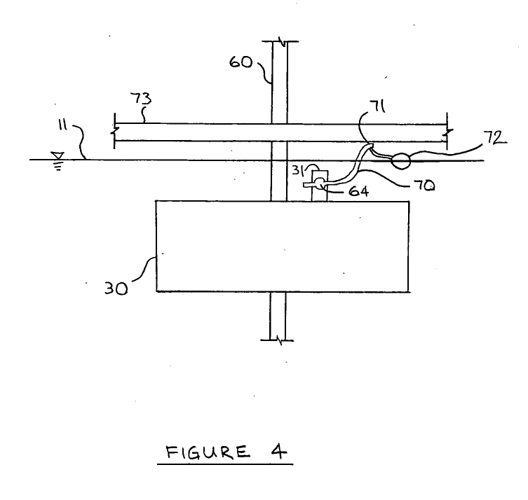

In another embodiment, shown in FIG. 4, there is at least one gas release means 31, with each gas release means 31 being a common plumbing valve, again operated by a typical control means 64. The gas release means 31 incorporate a curved trigger arm 70 having a cantilever end 71. Due to the curve of the trigger arm 70, the cantilever end 71 of each arm is located above the rotation point of the trigger arm 70. A float 72 is attached to the cantilever end 71, and a crossbar 73 is located above the top of the moving vessel's 30 upstroke. The crossbar 73 is placed at a location where it will engage the cantilever ends 71 when the moving vessel 30 is at the top of its upstroke.

When the moving vessel 30 sinks into the main tank 10, the float 72 rises in the water, pulling the cantilever end 71 up, thereby closing the gas release means 31. Then, when the moving vessel 30 approaches the top of its upstroke, the cantilever ends 71 engage the crossbar 73. After this point, as the moving vessel 30 continues to rise, the crossbar 73 forces the cantilever ends 71 to move downward relative to the rotation point of the trigger arm 70, thereby opening the gas release means 31 and releasing the gas in the moving vessel 30.

The embodiments disclosed above are merely representative of the apparatus and process and not meant for limitation of the invention. For example, one having ordinary skill in the art would understand that the individual features of several disclosed embodiments are interchangeable with the features of other embodiments. Consequently, it is understood that equivalents and substitutions for certain elements and components set forth above are part of the invention, and therefore the true scope and definition of the invention is to be as set forth in the following claims.

We claim:

1. An apparatus for capturing energy from gravitational and buoyancy forces, said apparatus comprising:
a moving vessel capable of sinking through water under the gravitational force of its own weight, and capable of receiving compressed gas such that the moving vessel rises through the water when the buoyancy forces caused by said compressed gas exceed the gravitational forces of said moving vessel's weight;
a charging vessel positioned below the moving vessel and capable of releasing compressed gas into the moving vessel;
a compression tank capable of compressing gas, said compression tank connected to the charging vessel such that the compression tank supplies the charging vessel with compressed gas;
a piston attached to the moving vessel and communicating with the compression tank such that the motion of the moving vessel causes the piston to compress gas in the compression tank; and
an energy recovery means attached to the piston, said energy recovery means capable of converting the kinetic energy in the piston into mechanical work.

2. The apparatus of claim 1 wherein the energy recovery means is a lever.

3. The apparatus of claim 1 wherein the compression tank further comprises a one-way exit valve permitting compressed gas to exit the compression tank, and a one-way entry valve permitting ambient gas to enter the compression tank.

4. The apparatus of claim 3 wherein the charging vessel further comprises a one-way charging valve permitting compressed gas from the compression tank to enter into the charging vessel, and a one-way contact valve permitting compressed gas in the charging vessel to be released into the moving vessel upon physical engagement between the moving vessel and the contact valve.

5. The apparatus of claim 4 wherein the moving vessel further comprises a gas release means.

6. A method of using gravitational forces and buoyancy forces to create useable energy, said method comprising the steps of:
introducing compressed gas into a charging vessel;
submerging a moving vessel under the gravitational force of its own weight until said moving vessel contacts said charging vessel;
releasing compressed gas from the charging vessel into the moving vessel, thus causing the buoyancy forces in the moving vessel to overcome said gravitational forces, thereby lifting the moving vessel;
compressing gas in a compression tank by using a piston attached to the moving vessel and communicating with the compression tank such that the gas in the compression tank is compressed when the moving vessel rises under said buoyancy forces;
introducing the compressed gas from the compression tank into the charging vessel;
releasing the compressed gas from the moving vessel when the piston is near the top of the compression tank, thus causing the gravitational force of the moving vessel to overcome the buoyancy force, thereby causing the moving vessel to submerge;
mechanically engaging said piston with an energy recovery means whereby the vertical movement of the piston causes the energy recovery means to move; and
recovering energy from said energy recovery means.

7. The method of claim 6 additionally comprising the step of drawing ambient gas into the compression tank by drawing the piston down through the compression tank as the moving vessel sinks under said gravitational forces.

8. A method of using gravitational forces and buoyancy forces to create useable energy, said method comprising the steps of:
submerging a moving vessel under the gravitational force of its own weight until said moving vessel contacts a charging vessel;
compressing gas in a compression tank by using a piston attached to the moving vessel and communicating with a compression tank such that gas in the compression tank is compressed when the moving vessel submerges under said gravitational forces;
introducing compressed gas from the compression tank into said charging vessel;
releasing compressed gas from the charging vessel into the moving vessel after the moving vessel contacts said charging vessel, thus causing the buoyancy forces in the moving vessel to overcome said gravitational forces, thereby lifting the moving vessel;
releasing the compressed gas from the moving vessel when the piston is near the top of the compression tank, thus causing the gravitational forces of the moving vessel to overcome the buoyancy forces, thereby causing the moving vessel to submerge;
mechanically engaging said piston with an energy recovery means whereby the vertical movement of the piston causes the energy recovery means to move; and
recovering energy from said energy recovery means.

9. The method of claim 8 additionally comprising the step of drawing ambient gas into the compression tank by moving the piston upward through the compression tank as the moving vessel rises under said buoyancy forces.
